(19) United States
(12) Patent Application Publication
(10) Pub. No.: US 2023/0406228 A1
(43) Pub. Date: Dec. 21, 2023

(54) Device for Evaluating Image Data in a Motor Vehicle

(71) Applicant: Bayerische Motoren Werke Aktiengesellschaft, Muenchen (DE)

(72) Inventor: Ioannis TOPTSIS, Putzbrunn (DE)

(21) Appl. No.: 18/030,931

(22) PCT Filed: Aug. 4, 2021
(86) PCT No.: PCT/EP2021/071753

§ 371 Date: Apr. 7, 2023

(30) Foreign Application Priority Data
Oct. 23, 2020 (DE) 10 2020 127 996.5

(51) Int. Cl. B60R 11/04; H04N 23/55; H04N 23/75

(52) U.S. Cl. CPC B60R 11/04; H04N 23/75; H04N 23/55

(57) ABSTRACT

A device for evaluating image data in a motor vehicle includes a sensor assembly including an optical sensor and at least one optical filter to change, for a first time interval of a phase, a light spectrum scanned by the optical sensor, and an evaluation device configured to use first evaluation logic to evaluate image data output by the optical sensor during the first time interval and to use additional evaluation logic to evaluate image data output by the optical sensor during an additional time interval of the phase.

### FIELD

The present invention relates to a device for evaluating image data in a motor vehicle.

### BACKGROUND AND SUMMARY

It is known that to provide assisted driving functions, which are provided by driver assistance systems installed in a vehicle, at least one optical sensor, but usually multiple optical sensors, in particular cameras, are installed in the vehicle. An optical sensor is to be understood here as a sensor having an electronic image converter, the image sensor. Image data are generated by the optical sensor by means of an optical projection of an image on the image converter.

The optical sensor typically operates in the spectrum of the light visible to humans, thus in a range of the electromagnetic wave spectrum designated as the light spectrum or color spectrum. The color spectrum essentially comprises electromagnetic waves having a wavelength of 400 nm to 700 nm.

While electromagnetic waves of other wavelength ranges, in particular in the infrared and ultraviolet range, cannot be perceived by humans, electronic sensors can detect electromagnetic waves outside the color spectrum. Such electronic sensors can be used in a vehicle in order to ascertain additional items of information about the vehicle surroundings in bad weather conditions, for example in fog. These items of information are, however, otherwise undetectable to the human eye in the visible color spectrum. Additional safety and warning functions for the vehicle user can thus be implemented on the basis of this information.

In addition to optical sensors which operate using the light spectrum, providing additional camera systems in the vehicle, which especially monitor ranges of the nonvisible spectrum, and in this case in particular the near-infrared and/or the near-ultraviolet range, is known.

Especially in vehicles such as passenger vehicles, however, a corresponding installation space has to be provided for each optical sensor, wherein this space always has tight dimensions and requires extensive design planning. Furthermore, each optical sensor, thus each camera, for example, has to be connected to a data and/or power supply, which in addition to the costs for the respective optical sensor also causes the costs for the infrastructure required for its operation.

The invention therefore has a goal of avoiding the use of additional optical sensors and thus above all saving installation space in the vehicle. The invention achieves this goal by way of the device as disclosed herein. Refinements of the invention are also the subject matter of the present disclosure.

In a first aspect, the invention provides a device for evaluating image data in a motor vehicle, including a sensor arrangement which includes an optical sensor and at least one optical filter, wherein the at least one optical filter is configured to change, for a first time interval of a phase, a light spectrum scanned by the one optical sensor. Furthermore, the device includes an evaluation device, which is configured to evaluate image data output by the optical sensor during the first time interval using a first evaluation logic, and to evaluate image data output during a second time interval of the phase using a further evaluation logic.

The sensor arrangement can include at least one second optical filter, which changes, for a second interval of the phase, the light spectrum scanned by the optical sensor.

The at least one optical filter and/or the at least one second optical filter can change the scanned light spectrum selectively and/or cyclically. In particular, it is possible to change alternately between a time interval in which the light is changed and a time interval in which the light is not changed. If multiple time intervals are provided in a phase in which the scanned light spectrum is changed by filtering, a different series of time intervals having changed spectrum and time intervals having unchanged spectrum can thus also be provided.

The evaluation device can include a second evaluation logic which evaluates the image data output by the optical sensor during the second time interval.

The at least one optical filter can be an infrared filter or a UV filter. The second optical filter can also be a UV filter or an infrared filter. If multiple filters are provided in the device, at least one filter is thus preferably a UV filter and one filter is an infrared filter.

The at least one optical filter can be brought into an optical axis of the sensor during the first time interval and/or the at least one second optical filter can be brought into an optical axis of the sensor during the second time interval. During the further time interval, preferably no filter is brought into the optical axis of the sensor. The filters can thus be provided, for example, as upstream filters in front of the optical sensor, which are switched or moved selectively or cyclically in front of the optical sensor.

The sensor arrangement can include an optical component which conducts the light spectrum filtered by the at least one optical filter and/or the light spectrum filtered by the at least one second optical filter to the optical sensor. This possibility can be provided alternatively or additionally for bringing a filter into an optical axis of the optical sensor. In particular, combinations are possible in such a way that an optical filter is brought into the optical axis of the optical sensor, while the light spectrum changed by another filter is conducted via the optical component to the optical sensor.

The at least one optical component can preferably be a prism or a mirror. The optical component can be movably mounted here, for example pivotably or rotatably. In particular, a series of optical components can be provided which conducts the changed light spectrum to the optical sensor.

Each of the time intervals of a phase can be of equal length here and the phase can preferably have one more time interval than filters are provided in the sensor arrangement. In particular, the phase has a time interval in which the light spectrum scanned by the at least one optical sensor is not changed.

A frame rate of the optical sensor can be selected here in dependence on the number of the filters provided in the sensor arrangement. In particular, the scanning rate of the sensor can be selected so that it is a multiple of the frame rate which the sensor would have if no filter were provided in the sensor arrangement or if it would operate in the light spectrum.

The evaluation logic can be changed or switched over in dependence on the time interval.

In a further aspect, an evaluation method is provided for image data by a device as described above, wherein an optical sensor of a sensor arrangement scans a light spectrum changed by an optical filter for a time interval of a phase and evaluates image data output on the basis of the scanned light spectrum using a first evaluation logic, and wherein the optical sensor scans a light spectrum during a further time interval and evaluates image data output on the basis of the scanned light spectrum using a further evaluation logic.

At least one evaluation logic is preferably provided, which evaluates image data which are generated by the optical sensor from a changed spectrum. Moreover, an evaluation logic is provided which evaluates image data which result from an unchanged light spectrum, thus from a time interval in which no filter is active. An evaluation logic is designed here for a specific frame rate. The system according to the invention is then designed so that images of the specific frame rate are still supplied for this evaluation logic, while the same number of images are supplied for the other evaluation logic, which evaluates image data based on a changed light spectrum. If a filter is present, the frame rate of the optical sensor is thus preferably doubled, so that the same number of images is available for each evaluation logic.

In particular, the evaluation logic is changed as soon as a filter is used. If a filter is used, the context of the evaluation logic or the evaluation logic itself is thus changed. The change takes place in particular in the evaluation device. Already known evaluation algorithms can thus be used at least for the evaluation of image data which result from an unchanged light spectrum.

The evaluation logic can be changed or switched over in dependence on or synchronously with the respective time interval.

The invention will now also be described with a view of the figures.

### BRIEF DESCRIPTION OF THE DRAWINGS

FIG. 1 shows a schematic representation of an embodiment of the invention.

FIG. 2 shows another schematic representation of a further embodiment of the invention.

FIG. 3 shows another schematic representation of still a further embodiment of the invention.

FIG. 4 shows a schematic overview of the invention.

### DETAILED DESCRIPTION

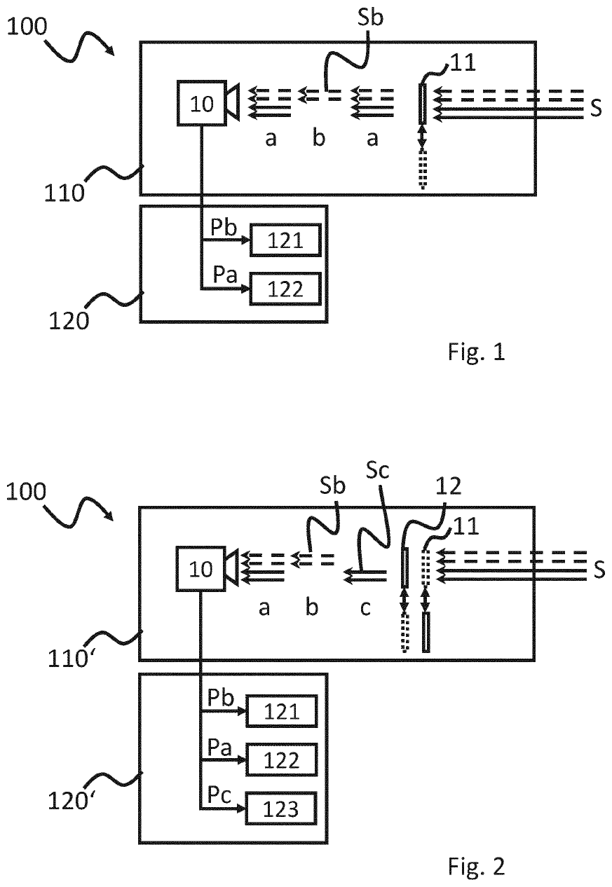

The present disclosure will now first be described with a view of FIG. 1.

FIG. 1 describes by way of example a first embodiment of the present disclosure having a device 100, which comprises a sensor arrangement 110 and an evaluation device 120. The sensor arrangement 110 includes an optical sensor 10, which is functionally connected by way of example to a first evaluation logic 121 and a further evaluation logic 122. It is to be understood that a physical and/or logical isolation between the sensor arrangement 110 and the evaluation device 120 is not necessary. A division between evaluation device 120 and sensor arrangement 110 is solely selected to illustrate the elements of the present disclosure. Furthermore, a first filter 11 is shown, which is provided in the sensor arrangement 110 so that it can selectively or cyclically change a spectrum S scanned by the sensor 10. It is shown by way of example that the sensor can be displaced from a position shown by a dot-dash line into a position in which it changes the light spectrum scanned or detected by the sensor 10. This can be carried out, for example, by means of a piezoelectric mechanism, which briefly displaces the first filter 11, or else also, for example, by arranging the first filter 11 on a disk segment, which is displaced by rotation temporarily into the optical axis of the sensor 10. It is shown by way of example that during a first time interval a, the spectrum S is scanned without change by the sensor 10. During a further time interval b, in contrast, the spectrum Sb changed by the filter 11 is scanned by the optical sensor 10. Of course, it is to be understood that the sequence of the time intervals a and b can also be exchanged. The one phase will thus in particular consist here of the time intervals a and b. A further time interval a is shown in FIG. 1 solely to illustrate a cyclic sequence of time intervals, in which the light spectrum S is changed or not changed, respectively.

A change of the spectrum is to be understood here to mean that the filter selects the radiation processed by the optical sensor, thus the spectrum of the electromagnetic waves, according to specific criteria, for example, one of the wavelengths, a polarization state, or a direction of incidence.

The at least one optical sensor 10, which is in particular a CCD sensor, a CMOS sensor, or a camera, generates image data from the scanned light spectrum S or the incident and scanned light. During the time interval a, image data Pa are generated and evaluated by the further evaluation logic 122. In the time interval b, in which the spectrum S is changed to the spectrum Sb by the at least one optical filter 11, which is in particular an infrared or ultraviolet filter, the image data Pb are evaluated by the first evaluation logic 121. The first evaluation logic 121 is an evaluation logic which is especially designed for the evaluation of the image data Pb, which are generated by the changed light spectrum Sb. In particular, it can be configured to evaluate infrared or ultraviolet images. The further evaluation logic 122 is, however, an evaluation logic which is designed to evaluate image data as are normally generated in the visible spectrum S by a camera.

As indicated in FIG. 1 by the sequence of the time intervals a and b, according to the embodiment, an alternating change preferably takes place between a time interval b, in which a change of the scanned light spectrum S takes place, and a time interval a, in which no change of the scanned light spectrum takes place. A change also takes place cyclically between the first evaluation logic 121 and the further evaluation logic 122. This change preferably follows synchronously with the change of the time intervals a, b.

FIG. 2 shows a further embodiment, wherein device parts which correspond to those from FIG. 1 have the same names. A device 100 is again shown, which displays a sensor arrangement 110′ and an evaluation device 120′. The sensor arrangement 110′ substantially corresponds here to the sensor arrangement 110 from FIG. 1. As shown in FIG. 2, however, a further optical filter 12 is provided in the sensor arrangement 110′. This second optical filter 12 is also configured to change the spectrum S scanned by the optical sensor 10. This takes place in a second time interval c and results in the changed spectrum Sc. In the illustrated example, the second optical filter 12 is arranged so that it changes the spectrum S to the spectrum Sc. The first optical filter 11 is not active by way of example in the illustrated example.

The optical sensor 10 therefore scans a sequence of time intervals a, b, c, wherein, for example, in a further time interval a, no change of the light spectrum S takes place, while in a first time interval b, a change of the light spectrum S by the first filter 11 takes place and/or in a second time interval c, a change of the light spectrum S by the second filter 12 takes place. In this case, it is thus preferably the case that only one optical filter 11, 12 changes the incident spectrum S or the spectrum S detected by the sensor 10. However, it is also possible that multiple filters change the spectrum S simultaneously in one time interval, so that, for example, two filters 11, 12 can be combined so that they offer a third filter option.

The evaluation device 120′, which again does not have to be separated physically or logically from the sensor arrangement 110′, includes three evaluation logics in the illustrated example, wherein the first evaluation logic 121 corresponds to that from FIG. 1 and is configured to process image data Pb, which are output by the sensor on the basis of the spectrum Sb in the first time interval b. The further evaluation logic 122 is also provided to evaluate image data Pa, which are generated during or based on the further time interval a. A second evaluation logic 123 is provided to evaluate the image data which are created during or based on the light spectrum Sc detected by the optical sensor 10. The second evaluation logic 123 is used to evaluate the image data Pc, which are generated by the sensor 10 when it scans the spectrum Sc, which is changed by the second filter 12.

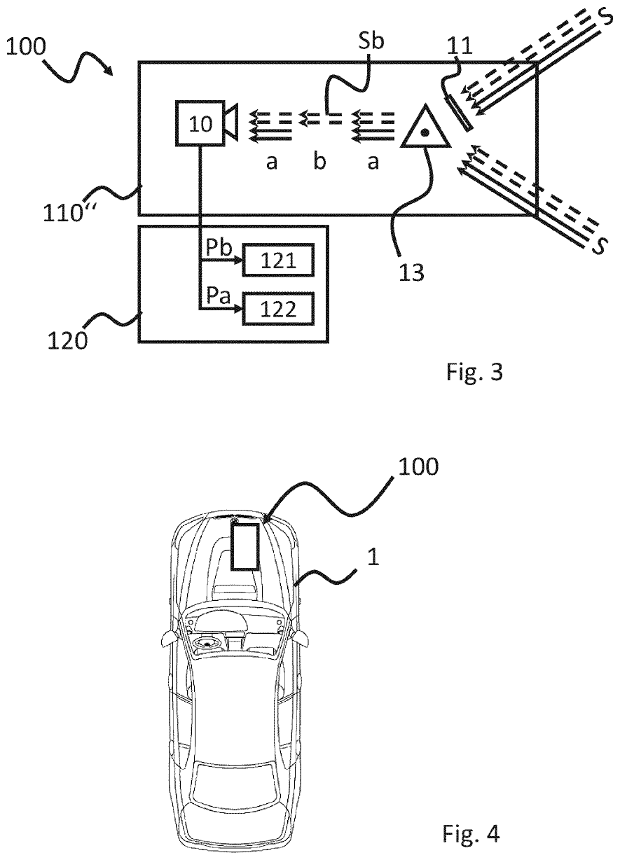

FIG. 3 shows still a further embodiment according to the present disclosure, which essentially shows elements from FIG. 1. Identical components are again provided with identical reference signs. In particular, the evaluation device 120 corresponds to that from FIG. 1.

The sensor arrangement 110″ is now changed in such a way that an optical component 13 is provided. The optical component 13 is in particular provided to conduct light changed by the first optical filter 11 or a spectrum changed by the optical filter 11 to the optical sensor 10. It is ensured by the design of the optical component 13 and its arrangement or its mounting that light having the spectrum S is conducted to the optical sensor 10 by the optical component during a time interval a, while in the time interval b, light of the changed spectrum Sb is conducted to the optical sensor, which is changed by the optical filter 11. It is shown solely by way of example that after the time interval b, a time interval a again follows in a new phase, in which light is conducted without change to the sensor. The first evaluation logic 121 and the further evaluation logic 122 are controlled here so that image data Pa, which are generated from the light scanned during the time interval a by the optical sensor 10, are again evaluated accordingly by the further evaluation logic 122, and image data Pb, which are generated by the sensor 10 during the time interval b, are evaluated by the first evaluation logic 121.

Finally, FIG. 4 shows an overview of the present disclosure, wherein the device 100 is arranged in a motor vehicle 1.

It is to be understood that the filters 11, 12 used are selected in dependence on the sensitivity of the optical sensor 10 or on an electronic image converter of the optical sensor 10. The optical sensor 10 can thus have, for example, a sensitivity in the infrared range (range 780 nm and 1 mm) or ultraviolet range (range 10 nm-400 nm), which are outside the visible spectrum. However, the spectrum of the changed light can be shifted toward this special sensitivity of the sensor by the filtering of the light with spectrum S using the filters 11, 12, so that the one optical sensor 10 can be used for scanning and evaluating various light spectra. Already available and inexpensive optical sensors can thus be used, but which, due to a use of the filters according to the present disclosure, can then scan light in the nonvisible range, in particular in the near ultraviolet or infrared range.

Furthermore, the further evaluation logic 122 can also be a known evaluation logic, which is designed for processing image data Pa, which are based on the basis of items of information in the visible light spectrum. The image data Pb, which have to be evaluated by the optical sensor 10 on the basis of the light having changed spectrum Sb, can be evaluated by the first evaluation logic 121, however. The first evaluation logic 121 can essentially correspond here to the further evaluation logic 122, which is solely differently parameterized or put in another context. This also applies to the second evaluation logic 123, which can also essentially correspond to the evaluation logic 121. This is then in turn differently parameterized, however, than the further evaluation logic 122 or the first evaluation logic 121 or is executed in a different context.

The frame rate of the optical sensor 10 is in particular dependent on the number of the filters 11, 12 used. An evaluation logic 122, which is already known, can thus be designed for processing images at 30 images (“frames”) per second. To be able to use the existing evaluation logic 122, it is now preferably provided that the frame rate of the optical sensor 10 is doubled upon use of a filter 11, 12. Thus, for example, a frame rate of 60 frames per second (abbreviated “fps”) can thus be provided, wherein for each image there is a change from the to another evaluation logic 121, 122 and one filter 11, 12 is activated or deactivated. Activate in this case means that the filter 11, 12 changes the spectrum S, while the filter 11, 12 does not change the spectrum S when it is deactivated. In particular, one image is generated by the optical sensor 10 with and the next image without filter 11, 12, or vice versa. For the image without filter 11, 12, the further evaluation logic 122 is then used, while for the first evaluation logic 121 or evaluation logic 123 is used. It is thus ensured that each evaluation logic 121, 122, 123 operates at 30 frames per second and no specific adaptation of the evaluation logic 121, 122, 123 with respect to the frame rate has to take place.

Of course, it is to be understood that different frame rates or multiples of frame rates can also be used. Accordingly, the original frame rate is further multiplied upon use of more than one filter 11, 12. As an example, for example, a frame rate of the optical sensor 10 can be increased from 30 frames per second to 90 frames per second if two filters 11, 12 are provided in the sensor arrangement 110. A different evaluation logic 121, 122, 123 is then activated per image. This means in particular that the optical sensor 10 scans light with unchanged spectrum S, light with spectrum Sb changed by the filter 11, and then light with spectrum Sc changed by the second filter 12, and accordingly respectively generates image data Pa, Pb, Pc therefrom. The evaluation of these image data is then assumed by the in this case three evaluation logics 121, 122, 123, which are switched in accordingly or are subject to a corresponding context change. It is also possible that multiple filters are combined to form one further filter.

1-12. (canceled)

13. A device for evaluating image data in a motor vehicle, the device comprising:
a sensor arrangement comprising an optical sensor and at least one optical filter, wherein the at least one optical filter is configured to change a light spectrum scanned by the optical sensor for a first time interval of a phase; and
an evaluation device configured to evaluate image data output by the optical sensor during the first time interval using a first evaluation logic, and to evaluate image data output during a further time interval of the phase using a further evaluation logic.

14. The device according to claim 13, wherein the at least one optical filter changes the scanned light spectrum selectively and/or cyclically.

15. The device according to claim 13, wherein the sensor arrangement comprises at least one second optical filter configured to change the light spectrum scanned by the optical sensor for a second time interval of the phase.

16. The device according to claim 15, wherein the evaluation device includes a second evaluation logic configured to evaluate the image data output by the optical sensor during the second time interval.

17. The device according to claim 15, wherein the at least one optical filter is an infrared filter and wherein the at least one second optical filter is a UV filter.

18. The device according to claim 13, wherein the at least one optical filter is brought into an optical axis of the optical sensor during at least the first time interval, and wherein the at least one optical filter is removed from the optical axis during the further time interval.

19. The device according to claim 13, wherein the sensor arrangement further comprises at least one optical component configured to conduct the light spectrum filtered by the at least one first optical filter to the optical sensor.

20. The device according to claim 19, wherein the at least one optical component comprises a movably mounted prism and/or mirror.

21. The device according to claim 13, wherein the first time interval and the further time interval are of equal length, and wherein the phase has a number of time intervals that is one more than a number of optical filters that are provided in the sensor arrangement.

22. The device according to claim 13, wherein an image scanning rate of the optical sensor is dependent on a number of optical filters provided in the sensor arrangement.

23. The device according to claim 13, wherein the first evaluation logic and the further evaluation logic are changed or switched over in dependence on the first time interval and the further time interval.

24. An evaluation method for image data, comprising:
during a first time interval of a phase:
scanning, by an optical sensor of a sensor arrangement, a first light spectrum changed by at least one optical filter; and
evaluating, by a first evaluation logic, image data output on a basis of the scanned first light spectrum; and
during a further time interval of the phase:
scanning, by the optical sensor, a second light spectrum; and
evaluating, by further evaluation logic, image data output on a basis of the scanned second light spectrum.

25. The evaluation method according to claim 24, further comprising:
changing the scanned light spectrum selectively and/or cyclically by the at least one optical filter.

26. The evaluation method according to claim 24, further comprising:
during a second time interval of the phase:
scanning, by the optical sensor, a third light spectrum changed by at least one second optical filter; and
evaluating, by a second evaluation logic, image data output on a basis of the scanned third light spectrum.

27. The evaluation method according to claim 24, further comprising:
bringing the at least one optical filter into an optical axis of the optical sensor during at least the first time interval; and
removing the at least one optical filter from the optical axis at least during the further time interval.

28. The evaluation method according to claim 24, further comprising:
conducting the light spectrum filtered by the at least one first optical filter to the optical sensor by at least one optical component.

29. The evaluation method according to claim 28, further comprising:
moving a movably mounted prism and/or mirror of the at least one optical component.

30. The evaluation method according to claim 24, wherein the first time interval and the further time interval are of equal length, and wherein the phase has a number of time intervals that is one more than a number of optical filters that are provided in the sensor arrangement.

31. The evaluation method according to claim 24, further comprising:
scanning, by the optical sensor, at an image scanning rate dependent on a number of optical filters provided in the sensor arrangement.

32. The evaluation method according to claim 24, further comprising:
changing or switching over the first evaluation logic and the further evaluation logic in dependence on the first time interval and the further time interval.
